(19) United States
(12) Patent Application Publication
(10) Pub. No.: US 2025/0206870 A1
(43) Pub. Date: Jun. 26, 2025

(54) A PANEL CONSTRUCTION, A PROCESS FOR PREPARING THE SAME AND USE THEREOF AS AN AUTOMOTIVE PART

(71) Applicant: BASF SE, Ludwigshafen am Rhein (DE)

(72) Inventors: Ali Zolali, Wyandotte, MI (US); Elias Ruda Shakour, Wyandotte, MI (US); Jeffrey M. Hagar, Wyandotte, MI (US)

(73) Assignee: BASF SE, Ludwigshafen am Rhein (DE)

(21) Appl. No.: 18/850,647

(22) PCT Filed: Mar. 24, 2023
(86) PCT No.: PCT/EP2023/057578

§ 371 Date: Sep. 25, 2024

Related U.S. Application Data
(60) Provisional application No. 63/326,350, filed on Apr. 1, 2022.

(30) Foreign Application Priority Data
May 12, 2022 (EP) 22172873.6

(51) Int. Cl. C08G 18/32; B01J 31/02; B01J 31/12; C08K 5/11; C08K 5/18; C08K 5/57; C08K 11/00

(52) U.S. Cl. CPC C08G 18/324; B01J 31/0237; B01J 31/122; C08K 5/11; C08K 5/18; C08K 5/57; C08K 11/00

(57) ABSTRACT

An isocyanate-reactive composition is used for the manufacture of a polyurethane resin. Said composition includes A) castor oil; B) at least one polyether polyol having an average functionality of from 2.0 to 4.0; C) at least one chain extender; and D) at least two catalysts selected from amine catalysts and/or alkyl tin catalysts.

### FIELD OF INVENTION

The present invention relates to an isocyanate-reactive composition for manufacture of a polyurethane resin, a panel construction, a process for preparing the same and use thereof as an automotive part.

### BACKGROUND OF THE INVENTION

Panel constructions are shaped parts which are used as structural reinforcement for automotives, for instance underbody panel are used commonly to reinforce the steering wheel panel. Typically, these panels comprise a mat layer saturated with a polyurethane resin in a closed mold.

These composites and the process for producing them are well-known in the state of the art. For instance, U.S. Pat. No. 9,375,893B2 discloses lightweight, strong, and durable automotive panels, in particular underbody shields obtained using panel constructions comprising a first and second composite fiber mat layer comprising non-woven fabrics.

State of art panel construction is represented by honeycomb-based composite constructions. For instance, EP1544179A2, concerns a honeycomb structure comprising a supporting base of glass fibers impregnated with a polyamide imide resin prepolymer.

Among available techniques for producing said panels, spray transfer molding (STM) is a fast and efficient process to manufacture panels that have low thickness, which is highly desirable for automotive applications. However, spray molding techniques involve the use of atomizer that are generally incompatible with high viscosity (>2000 cps at 23 C) resins.

More recently, US20210339484A1 identifies a polyurethane resin-honeycomb composite panels that have reduced thickness, while affording acceptable structural benefits.

However, a concern with existing resins is their poor adhesion, particularly with thermoplastic materials. Additionally, amidst growing environmental concerns, there is need to produce environmentally-sustainable composite material. Thus, it was an object of the present invention to provide polyurethane resins that are suitable for automotive panel construction and adaptable to spray molding application, which have high adhesion towards thermoplastics, have higher wettability of mat layer, while having lower environmental toxicity versus conventional polyurethane resins.

### SUMMARY OF THE INVENTION

Surprisingly, it has been found that the above-identified objects are met by providing an isocyanate-reactive composition for manufacture of a polyurethane resin as described hereinbelow, said composition comprising: A. castor oil; B. at least one polyether polyol having an average functionality of from 2.0 to 4.0; C. at least one chain extender; and D. at least two catalysts selected from amine catalysts and/or alkyl tin catalysts. Said composition provides low viscosity (<2000 cps at 23 C) with better moldability, higher wettability, no drip performance, higher adhesion to thermoplastic, while maintaining a lower environmental toxicity versus conventional polyurethane resins.

Accordingly, in one aspect, the presently claimed invention is directed to the isocyanate-reactive composition for manufacture of a polyurethane resin, said composition comprising: A. castor oil; B. at least one polyether polyol having an average functionality of from 2.0 to 4.0; C. at least one chain extender; and D. at least two catalysts selected from amine catalysts and/or alkyl tin catalysts.

In another aspect, the presently claimed invention is directed to a polyurethane resin obtainable by a process comprising reacting: A. an isocyanate; and B. the isocyanate-reactive composition as described herein.

In yet another aspect, the presently claimed invention is directed to a panel construction comprising A. at least one mat layer, B. a polyurethane film prepared from a polyurethane resin composition obtainable by a process comprising reacting: a. an isocyanate, b. the isocyanate-reactive composition as described herein, and C. a honeycomb layer adjacent to the mat layer and in contact with the polyurethane film, wherein the polyurethane resin composition is sprayed onto the at least one mat layer to form the polyurethane film.

In another aspect, the presently claimed invention is directed to process for preparing a panel construction, said process comprising the steps of: (S1) spraying a polyurethane resin composition onto at least one surface of a mat layer, wherein said polyurethane resin composition is obtainable by a process comprising reacting: a. an isocyanate, b. the isocyanate-reactive composition as described herein, wherein said polyurethane resin composition forms a polyurethane film on the at least one surface of a mat layer; and resulting in a pre-impregnated blank, and (S2) compression molding the pre-impregnated blank along with a honeycomb layer.

In another aspect, the presently claimed invention is directed to use of the panel construction as described herein, or as obtained by the process as described herein as an automotive part.

In yet another aspect, the presently claimed invention is directed to an automotive part comprising the panel construction as described herein or as obtained by the process as described herein.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention is directed towards the isocyanate-reactive composition for manufacture of a polyurethane resin, said composition comprising: A. castor oil; B. at least one polyether polyol having an average functionality of from 2.0 to 4.0; C. at least one chain extender; and D. at least two catalysts selected from amine catalysts and/or alkyl tin catalysts.

According to the invention, the composition comprises castor oil. Preferably, the castor oil comprises triglyceride of recinioleic acid in an amount >50 wt % with respect to the castor oil. More preferably, the castor oil comprises triglyceride of recinioleic acid in an amount >60 wt %, even more preferably in an amount >70 wt %, more preferably in an amount >80 wt %, even more preferably in an amount of 90 wt % with respect to the castor oil.

Preferably, castor oil content is in the range of from 25 to 60 wt. % with respect to the total weight of the composition. More preferably, castor oil content is in the range of from 28 to 45 wt. %, even more preferably of from 30 to 40 wt. %, most preferably of from 32 to 40 wt. %, with respect to the total weight of the composition.

According to the invention, the composition comprises at least one polyether polyol having an average functionality of from 2.0 to 4.0. Preferably, the polyether polyols are obtainable by known methods, for example by anionic polymerization or cationic polymerization.

For anionic polymerization, the polymerization of alkylene oxides having 2 to 4 carbon atoms in the alkylene moiety with addition of at least one starter molecule, comprising 1 to 4, preferably 2 to 3 and more preferably 2 reactive hydrogen atoms in bound form, in presence of an alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts.

For cationic polymerization, the polymerization of alkylene oxides having 2 to 4 carbon atoms in the alkylene moiety, with Lewis acids, such as antimony pentachloride, boron fluoride etherate and so on, or fuller's earth, as catalysts. As catalysts it is additionally possible to use double metal cyanide compounds, known as DMC catalysts.

Starter molecules are generally selected such that their average functionality is preferably of from 2.0 to 8.0, or of from 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Preferred amine containing starter molecules comprise of ethylenediamine, phenylenediamines, toluenediamine or isomers thereof. Particularly preferred amine containing starter molecule is ethylenediamine.

Hydroxyl-containing starter molecules comprise of sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Preferred hydroxyl containing starter molecules are sugar and sugar alcohols such as sucrose, sorbitol, glycerol, pentaerythritol, trimethylolpropane and mixtures thereof. In some embodiments the hydroxyl containing starter molecules are sucrose, glycerol, pentaerythritol and trimethylolpropane.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. Preferred alkylene oxides are propylene oxide and/or ethylene oxide. In some preferred embodiments, the alkylene oxides are mixtures of ethylene oxide and propylene oxide that comprise more than 50 wt.-% of propylene oxide.

Preferably, the polyether polyol has a hydroxyl number of from 15 mg KOH/g to 1800 mg KOH/g as determined by DIN 53240. More preferably, the polyether polyol has a hydroxyl number of from 45 mg KOH/g to 1700 mg KOH/g, even more preferably of from 60 mg KOH/g to 1600 mg KOH/g, more preferably of from 100 mg KOH/g to 1500 mg KOH/g, even more preferably of from 500 mg KOH/g to 1300 mg KOH/g, more preferably of from 500 mg KOH/g to 1100 mg KOH/g, most preferably of from 500 mg KOH/g to 1000 mg KOH/g as determined by DIN 53240.

Preferably, the polyether polyol has a weight average molecular weight in the range of from 50 to 250 g/mol as determined by gel permeation chromatography. More preferably, the polyether polyol has a weight average molecular weight in the range of from 80 to 220 g/mol, even more preferably of from 100 to 200 g/mol, most preferably of from 120 to 200 g/mol, as determined by gel permeation chromatography.

Preferably, the total polyether polyol content is in the range of from 35 to 65 wt. % with respect to the total weight of the composition. More preferably, the total polyether polyol content is in the range of from 38 to 55 wt. %, even more preferably, of from 40 to 50 wt. %, with respect to the total weight of the composition

Preferably, the weight ratio of the at least one polyether polyol to castor oil in the range of from 0.5 to 6.0. More preferably, the weight ratio of the at least one polyether polyol to castor oil is in the range of from 0.7 to 4.8, even more preferably, of from 0.9 to 3.5.

According to the invention, the composition comprises at least one chain extender. The chain extender is different from the polyether polyol. Chain extenders are preferably low molecular weight compounds having at least two isocyanate-reactive groups and having molecular weight less than 350 g/mol, more preferably of from 60 to less 300 g/mol, even more preferably of from 60 to less 200 g/mol. Chain extenders and/or cross linkers used are preferably alkanol amines and in particular diols and/or triols having molecular weights preferably of from 60 g/mol to 300 g/mol. Suitable amounts of these chain extenders and/or cross linkers can be added and are known to the person skilled in the art. Preferably, bifunctional chain extenders, trifunctional and higher-functional cross linkers or, if appropriate, mixtures thereof might be added.

Where low molecular weight chain extenders and/or crosslinking agents are used, it is possible to use chain extenders that are known in the context of polyurethane production, while chain extenders have a functionality of 2 and crosslinkers have a functionality of 3 or more. Chain extenders and/or crosslinking agents can be used to adjust mechanical properties such as hardness or elongation. This is known to a person skilled in the art. Examples of chain extenders and crosslinkers will include aliphatic, cycloaliphatic and/or araliphatic or aromatic diols having 2 to 14, preferably 2 to 10 carbon atoms, such as ethylene glycol, 1,3-propanediol, 1,4-butanediol, 1,6-hexanediol, 1,10-decanediol and bis(2-hydroxyethyl)hydroquinone, 1,2-, 1,3-, 1,4-dihydroxycyclohexane, diethylene glycol, dipropylene glycol, tripropylene glycol, triols, such as 1,2,4-, 1,3,5-trihydroxycyclohexane, glycerol and trimethylolpropane, and hydroxyl-containing polyalkylene oxides of low molecular weight that are based on ethylene oxide and/or on 1,2-propylene oxide and on the aforementioned diols and/or triols as starter molecules. Further possible low molecular weight chain extenders and/or crosslinking agents are specified for example in “Kunststoffhandbuch, volume 7, Polyurethane”, Carl Hanser Verlag, 3rd edition 1993, sections 3.2 and 3.3.2. If chain extender is used, it is preferably selected from, diethylene glycol, ethylene glycol, propane diol, 1,4 butane diol, 1,6-hexane diol or diethyltoluenediamine. More preferably chain extender is selected from, diethylene glycol, ethylene glycol, diethyltoluenediamine, or 1,4 butane diol. Even more preferably chain extender is selected from diethyltoluenediamine or diethylene glycol, most preferably chain extender is selected from diethylene glycol.

Preferably, commercially available chain extenders that are reactive towards isocyanate can also be employed, for e.g. Sovermol®, Pluracol® and Quadrol® from BASF.

Preferably, the at least one chain extender content is in the range of from 1 to 15 wt. % with respect to the total weight of the composition. More preferably, the at least one chain extender content is in the range of from 1 to 12 wt. %, even more preferably of from 2 to 10 wt %, even more preferably of from 2 to 8 wt %, with respect to the total weight of the composition.

According to the invention, the composition comprises at least two catalysts selected from amine catalysts and/or alkyl tin catalysts.

Preferably amine catalysts are selected from diethyltoluenediamine, 4,4′-methylenebis(2-methylcyclohexyl-amine), or 1-[bis[3-(dimethylamino)propyl]amino]-2-propanol.

Preferably, the alkyl tin catalysts are selected from methyl organotin catalyst, butyl organo tin catalyst or octyl organotin catalyst.

Methyl organotin catalysts that are well known in the art, are suitable for the present application. Preferably, the methyl organotin catalyst is dimethyltin dineodecanoate.

Butyl organotin catalysts that are well known in the art, are suitable for the present application. Preferably, the butyl organotin catalyst is selected from dibutyltin dilaurate.

Octyl organotin catalysts that are well known in the art, are suitable for the present application. Preferably, the octyl organotin catalyst is selected from dioctyltin dithioglycolate or dioctyltin mercaptide.

Preferably, the alkyl tin catalysts are selected from dimethyltin dineodecanoate, dibutyltin dilaurate, dioctyltin dithioglycolate or dioctyltin mercaptide.

Preferably, the composition comprises a combination of two different amine catalysts or a combination of at least one amine and at least one alkyl tin catalyst. More preferably, composition comprises a combination of two different amine catalysts. Even more preferably, the composition comprises at least one amine catalyst and at least one alkyl tin catalyst.

Preferably, the composition comprises a combination of 1-[bis[3-(dimethylamino)propyl]amino]-2-propanol and one other catalyst selected from diethyltoluenediamine and dioctyltin dithioglycolate. More preferably, the composition comprises a combination of diethyltoluenediamine and 1-[bis[3-(dimethylamino)propyl]amino]-2-propanol. Even more preferably, the composition comprises a combination of dioctyltin dithioglycolate and 1-[bis[3-(dimethylamino)propyl]amino]-2-propanol.

More preferably, the composition comprises diethyltoluenediamine, dioctyltin dithioglycolate, and 1-[bis[3-(dimethylamino)propyl]amino]-2-propanol.

The at least two catalysts selected from amine catalysts and/or alkyl tin catalysts, can be present in amounts preferably up to 20 wt.-%, more preferably from 0.5 to 17 wt %, even more preferably from 1 to 15 wt %, based on the total weight of the polyurethane resin composition.

Preferably, the composition further comprises auxiliary catalysts and additives. The auxiliary catalyst is different from the at least two catalysts selected from amine catalysts and/or alkyl tin catalysts. Suitable auxiliary catalyst for the polyurethane resin composition is well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

Preferred tertiary amines are triethylamine, tributylamine, N-methylmorpholine, N-ethylmorpholine, N,N, N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethylaminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, tris(dimethylaminopropyl)hexahydro-1,3,5-triazin can also be used.

Preferred metal catalysts include metal salts and organometallics comprising tin-, titanium-, zirconium-, hafnium, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

The auxiliary catalysts, as described hereinabove, can be present in amounts preferably up to 20 wt.-% based on the total weight of the polyurethane resin composition.

If present, additives can comprise one or more pigments, dyes, flame retardants, hindered amine light stabilizers, ultraviolet light absorbers, stabilizers, defoamers, internal release agents, desiccants, blowing agents and anti-static agents or a combination thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993. Suitable amounts of these additives are well known to the person skilled in the art. However, for instance, the additives can be present in amounts preferably up to 20 wt.-% based on the total weight of the polyurethane resin composition.

Preferably, the polyurethane resin composition, as described hereinabove, can also comprise a reinforcing agent. Suitable reinforcing agents refer to fillers in the present context.

Suitable fillers include, such as, silicatic minerals, examples being finely ground quartzes, phyllosilicates, such as antigorite, serpentine, homblendes, amphibols, chrysotile, and talc; metal oxides, such as kaolin, aluminum oxides, aluminium hydroxides, magnesium hydroxides, hydromagnesite, titanium oxides and iron oxides, metal salts such as chalk, heavy spar and inorganic pigments, such as cadmium sulfide, zinc sulfide, and also glass and others. Preference is given to using kaolin (china clay), finely ground quartzes, aluminum silicate, and coprecipitates of barium sulfate and aluminum silicate.

Preferred for use as fillers are those having an average particle diameter in the range of ≥0.1 μm to ≤500 μm, or more preferably in the range of ≥1 μm to ≤100 μm, or even more preferably in the range of ≥1 μm to ≤10 μm. Diameter in this context, in the case of non-spherical particles, refers to their extent along the shortest axis in space.

Suitable amounts of the fillers can be present in the polyurethane resin composition which are known to the person skilled in the art. For instance, fillers can be present in an amount up to 50 wt.-%, based on the total weight of the polyurethane resin composition.

Another aspect, the presently claimed invention is directed to a polyurethane resin obtainable by a process comprising reacting: A. at least one isocyanate; and B. the isocyanate-reactive composition as described herein.

Preferably, the isocyanate comprises methylene diphenyl diisocyanate, polymeric methylene diphenyl diisocyanate or a combination thereof. More preferably, the isocyanate is methylene diphenyl diisocyanate.

Preferably, the molar ratio of the sum total of the functionalities of the isocyanate-reactive composition used to the sum total of the functionalities of the isocyanate used is in the range from 1:0.8 to 1:1.3. More preferably, the molar ratio of the sum total of the functionalities of the isocyanate-reactive composition used to the sum total of the functionalities of the isocyanate used is in the range from 1:0.85 to 1:1.25; even more preferably, from 1:0.9 to 1:1.20.

Preferably, polyurethane resin is adaptable to spray molding. Spray transfer molding or spray molding is a process where atomized polyurethane particles are sprayed onto a non-woven material with a high-pressure nozzle or atomizer, then molded into the desired shape, providing a rigid, lightweight design. In a typical STM process, the first 60-90 seconds of the process is where the fabric is impregnated outside the mold using a high-pressure spray process, then molded in a compression press. A dry fiber or mat layer is held by a programmable robot that has an optimized and controlled spray pattern. It is then sprayed using a high-pressure nozzle head atomizing the polyurethane resin. This is followed by curing of the impregnated mat layer.

The resin of the present invention has a viscosity ≤2000 cps at 23 C, thus making it highly suitable for spray molding techniques. Preferably, the resin has a viscosity ≤1800 cps at 23 C, even more preferably ≤1500 cps at 23 C.

Yet another aspect of the present invention is directed towards a panel construction comprising A. at least one mat layer, B. a polyurethane film prepared from a polyurethane resin composition obtainable by a process comprising reacting: a. at least one isocyanate, b. the isocyanate-reactive composition as described herein, C. a honeycomb layer adjacent to the mat layer and in contact with the polyurethane film, wherein the polyurethane resin composition is sprayed onto the at least one mat layer to form the polyurethane film.

Preferably, in the panel construction, as described hereinabove, there is no requirement of an adhesive and/or a fastening means to bind the polyurethane film onto the at least one mat layer. Advantages associated with the absence of an adhesive and/or fastening means are control on the thickness of the panel construction and faster and economical production of the panel construction.

Other advantages of the panel construction are that they are mechanically stable, are seamless panels, can employ a variety of colours via incorporation of pigments, are field repairable with auto body techniques, have good thermal shock resistance, have high strength/low weight, have easy handling and mobility, reduce production steps, have high sound damping, are weather and moisture resistant and are non-permeable.

Preferably, the panel construction has a thickness preferably of from 0.5 mm to 30 mm, or of from 0.5 mm to 20 mm or of from 0.5 mm to 10 mm.

Preferably, the mat layer, as described hereinabove, comprises non-woven fibers or fabric, woven fabrics or non-crimp fabrics. More preferably, the mats comprise non-woven fibers.

Preferably, the non-woven fibers are natural, synthetic or glass fibers.

Preferably, the synthetic fibers are selected from carbon fibers or polyester fibers.

Preferably, the natural fibers are cellulosic bast fibers.

Preferably, the non-woven fibers also contain a small amount of synthetic thermoplastic fiber, for instance polyethylene terephthalate fibers (PET). The fibers can be synthetic polyester fibers or other fibers of similar characteristics.

More preferably, the mat layer comprises non-woven cellulosic bast fiber, jute fiber, kenaf fiber, bamboo fiber, non-woven polyester fiber, poly(methyl methacrylate), acrylonitrile butadiene styrene (ABS), polycarbonate, polypropylene, glass fiber, or a combination of two or more thereof. Even more preferably, the mat layer comprises non-woven cellulosic bast fiber, non-woven polyester fiber, poly(methyl methacrylate) (PMMA), acrylonitrile butadiene styrene (ABS), polycarbonate, polypropylene, or a combination of two or more thereof. The polyurethane resin, as described herein, is highly compatible for use with other plastics such as PMMA, polyester, polycarbonate, polypropylene, and ABS and displays surprising adhesion behaviour with said plastics (as can be seen in example section hereinbelow).

Preferably, the mat layer comprises glass fibers. The presence of glass fibers embedded in the panel construction dramatically improves its dimensional stability, while all other desirable mechanical and processing properties are maintained. Suitable glass mat layers are well known to the person skilled in the art. For example, chopped glass fibers and continuous glass fibers can be used for this purpose.

Preferably, the mat layer is obtained from chopped glass fibers. The chopped glass fibers can be obtained in any shape and size. For instance, the chopped glass fibers can be, such as, a strand of fiber having a lateral and through-plane dimension or a spherical particle having diameter. The present invention is not limited by the choice of the shape and size of the chopped glass fibers as the person skilled in the art is aware of the same. Preferably, the chopped glass fiber has a length of from 10 mm to 150 mm, or of from 10 mm to 130 mm, or of from 10 mm to 100 mm.

Preferably, the honeycomb layer comprises at least one material selected from cardboard, polypropylene, recycled thermoplastics, polycarbonate or aluminium.

Although, any suitable binding agent can be used for binding the chopped glass fibers, preferred is an acrylic binder. The acrylic binder is a cured aqueous based acrylic resin. The binder cures, for instance, through carboxylic groups and a multi-functional alcohol.

Acrylic binders are polymers or copolymers containing units of acrylic acid, methacrylic acid, their esters or related derivatives. The acrylic binders are for instance formed by aqueous emulsion polymerization employing (meth)acrylic acid (where the convention (meth)acrylic is intended to embrace both acrylic and methacrylic), 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, bornyl(meth)acrylate, or mixtures thereof.

Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters and similar compounds. The selection and amount of monomer may influence the adhesion of the PU with mat layer.

Multi-functional alcohols are for instance hydroquinone, 4,4′-dihydroxydiphenyl, 2,2-bis(4-hydroxyphenyl)propane, cresols or alkylene polyols containing 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol, tripentaerythritol and sorbitol.

The aqueous based acrylic binders are commercially available under the ACRODUR® name from BASF.

Preferably, the aqueous based acrylic resin is infused in the mat. That is to say, the mat is impregnated with the acrylic resin. The mats are compressed and cured with heat and pressure. Pressure is not required for curing, but for setting a desired thickness or density or shape. Forming takes place for instance in a heated, shaped tool to a desired shape.

The aqueous based acrylic binder may be applied to the non-woven fibers or fabrics either through a dipand-squeeze method, a curtain coater or a foam injection method. The mixture is dried to a low moisture content, preferably in an amount of from 4 wt.-% to 7 wt.-%, prior to thermal curing.

During initial heating and compression, compression release allows moisture to vent. The number of releases depends on the amount of moisture contained in the un-cured mat. The cured mat does not contain significant amounts of water. Preferably, the amount of water is of from 0 wt.-% to 3 wt.-% or based on the dry weight of the mat layer.

Once cured, the mat does not significantly swell. A preferred mat basis weight is of from 100 grams/square meter (gsm) to 1400 grams/square meter. The acrylic resin loading is preferably of from 15 wt.-% to 50 wt.-%, or of from 20 wt.-% to 40 wt.-% of dried resin, based on the finished mat weight.

Preferably, if the mat layer comprises continuous glass fibers, use of the binding agents, as described hereinabove, can be avoided. The present invention is not limited by the choice of the shape and size of the continuous glass fibers as the person skilled in the art is aware of the same. The continuous glass fibers can be oriented in one direction or in several directions, for instance, lateral, perpendicular or any angle between lateral and perpendicular. The mat layer comprising of continuous glass fibers has a nominal weight preferably of from 100 g/m² to 1000 g/m.

The mat layer, as described hereinabove, preferably has an area weight preferably of from 100 g/m² to 1500 g/m² and a thickness preferably of from 0.5 mm to 30 mm. Suitable techniques to measure the area weight and thickness are well known to the person skilled in the art.

Preferably, the panel construction comprises more than one mat layer, e.g. two, three, four or five mat layers to form a multi-layered system. In such a case, the mats can be identical or different. They can be of the same basis weight or thickness or be of different basis weight or thickness. Also, the fibers employed in the multi-layered system can be same or different. The choice and selection of the number of layers and the mat therefor is well known to the person skilled in the art.

Preferably, the mat layer can be a hybrid layer comprising of at least one layer of chopped glass fibers and at least one layer of continuous glass fibers. More preferably, it can also contain a thin film or scrim to enhance surface quality. The said thin film or scrim can be inserted on top of the hybrid layer.

Preferably, the panel construction is a monolithic composite, also referred to as monolithic panel construction, comprising a single mat layer and the polyurethane film, as described hereinabove. The said polyurethane film is prepared from the polyurethane resin composition which is sprayed onto the mat layer. In the present context, the term “polyurethane film” refers to the atomized polyurethane resin composition which, when sprayed onto the mat layer, binds itself to the mat layer and has no thickness of its own. That is, to say, that the polyurethane film does not exists as a separate layer onto the mat layer. Also, the term “atomized” herein refers to the particles or droplets of the polyurethane resin composition obtained from suitable spraying means, such as but not limited to a nozzle or an atomizer.

Preferably, the polyurethane resin composition is sprayed onto the at least one mat layer in an amount of from 450 gsm to 1500 gsm, more preferably of from 450 gsm to 1200 gsm, even more preferably of from 450 gsm to 1000 gsm, most preferably of from 450 gsm to 900 gsm.

In another preferred embodiment, the monolithic composite can further comprise additional materials, disposed on the said monolithic composite using suitable techniques known to the person skilled in the art. These additional materials can be, such as, polyisocyanate polyaddition products. By the term “polyisocyanate polyaddition products”, it is referred to the reaction products of suitable amounts of polyisocyanates and compounds reactive towards isocyanate having preferably a molecular weight of 500 g/mol or more.

The polyisocyanate polyaddition products include, cellular polyurethane elastomers and flexible, semi rigid or rigid polyurethane foams. In an exemplary embodiment, at least one of the polyisocyanate polyaddition product, such as, polyurethane-ureas, open and closed polyurethane foams is disposed on the monolithic panel construction. For instance, the polyisocyanate polyaddition products can be disposed as additional layers or sprayed or impregnated on the monolithic panel construction. The addition of these polyisocyanate polyaddition products further enhances the mechanical properties of the monolithic panel construction and enhances suitability for use, such as, in the automotive industry.

Preferably, the isocyanate comprises methylene diphenyl diisocyanate, polymeric methylene diphenyl diisocyanate or a combination thereof. More preferably, the isocyanate is methylene diphenyl diisocyanate.

The polyurethane film, as described hereinabove, is prepared from the polyurethane resin composition obtainable by a process comprising reacting:
(a) At least one isocyanate, and
(b) the isocyanate-reactive composition, as described herein.

In general, the isocyanate(s) can be present in monomeric form, in polymeric form, or as mixture of monomeric and polymeric forms. The term “polymeric” refers to the polymeric grade of the aliphatic, aromatic isocyanate, or mixtures thereof comprising dimers, trimers, higher homologues and/or oligomers.

By the term “aromatic isocyanate”, it is referred to molecules having two or more isocyanate groups attached directly and/or indirectly to the aromatic ring. Preferably, the isocyanate is an aromatic isocyanate selected from toluene diisocyanate; polymeric toluene diisocyanate, methylene diphenyl diisocyanate (or monomeric MDI); polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate or mixtures thereof. More preferably, the aromatic isocyanates is selected from toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate or mixtures thereof. Even more preferably, the aromatic isocyanates is selected from toluene diisocyanate; polymeric toluene diisocyanate, methylene diphenyl diisocyanate; polymeric methylene diphenyl diisocyanate, m-phenylene diisocyanate, or 1,5-naphthalene diisocyanate or mixtures thereof. Still more preferably, the aromatic isocyanates is selected from toluene diisocyanate; polymeric toluene diisocyanate, methylene diphenyl diisocyanate, polymeric methylene diphenyl diisocyanate, or mixtures thereof. More preferably, the isocyanate is methylene diphenyl diisocyanate, or polymeric methylene diphenyl diisocyanate.

Preferably, the aromatic isocyanates are monomeric MDI and/or polymeric MDI.

Preferably, the aromatic isocyanate(s) is monomeric MDI. More preferably, monomeric MDI is selected from 4,4′-MDI, 2,2′-MDI and 2,4′-MDI, or combinations of two or more of the aforementioned.

Preferably, the aromatic isocyanate(s) is polymeric MDI. Commercially available isocyanates available under the tradename, such as, Lupranat® from BASF can also be used for the purpose of the present invention.

More preferably, polymeric MDIs comprise of varying amounts of isomers, for example 4,4′-, 2,2′- and 2,4′-MDI. The amount of 4,4′MDI isomers is preferably from 26 wt. % to 98 wt. %, or more preferably from 30 wt. % to 95 wt. %, or even more preferably from 30 wt. % to 80 wt. %, with respect to the isomers, the balance being said oligomeric species. The methylene diphenyl diisocyanate isomers are often a mixture of 4,4-methylene diphenyl diisocyanate, 2,4′-methylene diphenyl diisocyanate and very low levels of 2,2′-methylene di-phenyl diisocyanate.

From the context of present invention, the purity of the polymeric MDI or pMDI is not important. Preferably, the pMDI used according to the invention has an iron content of from 1 to 100 ppm, or 1 to 70 ppm, or 1 to 80 ppm, or 1 to 60 ppm, based on the total amount of the pMDI.

Preferably, the pMDI has a NCO content in the range of from 22 to 40 wt. %, or 25 to 37 wt. %, or 28 to 35 wt. %, or 30 to 33 wt. %, based on total weight of pMDI.

Polymeric methylene diphenyl diisocyanate tends to have isocyanate functionalities of higher than 2. Preferably, the pMDI has a functionality of at least 2.3, or at least 2.5, or at least 2.7. More preferably, the pMDI has a functionality in the range from 2.3 to 4.5, or 2.5 to 4.3, or 2.5 to 4.0.

In addition, polymeric isocyanates include reaction products of polyisocyanates with polyhydric polyols and their mixtures with other diisocyanates and polyisocyanates can also be used.

Preferably, the isocyanate has an average functionality of at least 2.0; or of from 2.0 to 3.0. These isocyanates preferably comprise of aliphatic isocyanates or aromatic isocyanates or a combination thereof.

Preferably, the amount of isocyanates in the polyurethane resin is such that the isocyanate index is preferably of from 70 to 350, or of from 80 to 300, or of from 90 to 200, or of from 100 to 150. The isocyanate index of 100 corresponds to one isocyanate group per one isocyanate reactive group. 20 In another aspect, the presently claimed invention is directed to process for preparing a panel construction, said process comprising the steps of: (S1) spraying a polyurethane resin composition onto at least one surface of a mat layer, wherein said polyurethane resin composition is obtainable by the process comprising reacting: a. an isocyanate, b. the isocyanate-reactive composition as described herein, wherein said polyurethane resin composition forms a polyurethane film on the at least one surface of a mat layer; and resulting in a pre-impregnated blank, and (S2) compression molding the pre-impregnated blank along with honeycomb layer.

The polyurethane resin composition, the isocyanate, the compounds reactive towards isocyanate, the catalysts, the additives and the fillers that are used in the process according to the present invention are described hereinabove.

Preferably, the above described process is a spray transfer molding process.

In step (S1), the spraying of the polyurethane resin composition obtainable by a process comprising reacting the isocyanate and the compound reactive towards isocyanate refers to a two-component system which comprises of an isocyanate component and a component comprising the compounds reactive towards isocyanate. Preferably, the two-component system comprises the isocyanate component and the polyol component comprising at least one polyether polyol having an average functionality of from 2.0 to 4.0. By the term “component”, it is referred to the mixture comprising isocyanates along with catalysts, additives and fillers and polyol, as described hereinabove. The presence of catalysts, additives and fillers in the polyol component and/or the isocyanate component depends on the desired properties of the final polyurethane resin composition. In an exemplary embodiment, the polyol component can comprise polyols, catalysts, additives and fillers, while the isocyanate component is majorly comprised of isocyanates, as described hereinabove.

Furthermore, a multicomponent system comprising more than two components, can also be employed. For instance, in addition to the conventionally used polyol component and the isocyanate component, at least one additional component can be present. Suitable compounds for the additional components can comprise of compounds reactive towards isocyanate, isocyanates, catalysts, additives, fillers and mixtures thereof.

More preferably, the at least one additional component is different from the polyol component and the isocyanate component.

Spraying of the polyurethane resin composition onto the at least one mat layer in the step (S1) can be carried out using suitable means well known to the person skilled in the art (refer Ullman's encylcopedia of industrial chemistry; DOI: 10.1002/14356007). However, the isocyanate and the component reactive towards isocyanate can be mixed in a mixing device to obtain a reactive mixture before spraying it onto the at least one mat layer as the polyurethane composition to obtain the pre-impregnated blank. Suitable mixing device for this purpose are preferably a mixing head or a static mixer.

In an exemplary embodiment, the reaction mixture is obtained by feeding at least two streams into the mixing device, wherein:
(i) a first stream comprises at least one isocyanate component, and
(ii) a second stream comprises at least one polyol component,
wherein at least two catalysts, the additive and optionally, the filler is present in at least one of (i) and (ii).

Suitable temperatures for processing the reaction mixture are well known to the person skilled in the art.

In a preferred embodiment, the first stream and the second stream, independent of each other, can be premixed in suitable mixing means, such as, a static mixer.

The mixing device can be a low pressure or high-pressure mixing device comprising:
pumps to feed the streams,
a high-pressure mixing head in which the streams, as described hereinabove, are mixed,
a first feed line fitted to the high-pressure mixing head through which the first stream is introduced into the mixing head, and
a second feed line fitted to the high-pressure mixing head through which the second stream is introduced into the mixing head.

Optionally, the mixing device, as described hereinabove, can further comprise at least one measurement and control unit for establishing the pressures of each feed lines in the mixing head. Also, the term “low pressure” here refers to a pressure of from 0.1 MPa to 5 MPa, while the term “high-pressure” refers to pressure above 5 MPa.

Preferably, the reaction mixture is passed from the mixing head into the mixing device. A solid/gas mixture can be added through additional inlets. By “solid”, it is referred to the fillers, as described hereinabove, which are in a solid state of matter.

The reaction mixture obtained from the mixing device is fed to the spraying means. Suitable spraying means include, but are not limited to, spray heads. In a preferred embodiment, the spray head for spraying the polyurethane resin composition comprises at least one polyurethane spray jet. The polyurethane spray jet essentially consists of fine particles or droplets of the polyurethane resin composition, i.e. of the reaction mixture, preferably dispersed in a gas stream. Such a polyurethane spray jet can be obtained in different ways, for example, by atomizing a liquid jet of the reaction mixture of the polyurethane resin composition by a gas stream introduced into it, or by the ejection of a liquid jet of the reaction mixture from a corresponding nozzle or atomizer. By the term “liquid jet of the reaction mixture”, it is referred to the fluid jet of the reaction mixture of the polyurethane resin composition that is not yet in the form of fine reaction mixture droplets dispersed in a gas stream, i.e. especially in a liquid viscous phase. Thus, in particular, such a “liquid Jet of the reaction mixture” does not mean a polyurethane spray jet, as described above.

Such methods are described, for example in, DE 10 2005 048 874 A1, DE 101 61 600 A1, WO 2007/073825 A2, U.S. Pat. No. 3,107,057 A and DE 1 202 977 B, all incorporated herein by reference.

Alternatively, a solid containing gas stream can also be employed instead of the gas stream, as described hereinabove. The solid-containing gas stream is preferably prepared by passing the gas stream through solid-containing metering cells of a cellular wheel sluice. By the flushing of the cellular spaces, the solid is dragged along by the pressurized air stream and transported to the mixing head as a solid/air or solid/gas mixture. To avoid pulsation, the channel inside the metering sluice must be designed with a diameter that excludes positive overlap. This embodiment further ensures that a quantitatively unchanged air flow rate for spraying the reaction mixture is available even when the cellular wheel sluice metering is turned off of its revolutions per minute is changed, and thus spraying can be effected alternatively without or with variable filler quantities. As a particular advantage of such a cellular wheel sluice, the solid proportion in the pre-impregnated blank to be prepared can be variably adjusted.

The polyurethane spray jet, as described hereinabove, impinges on a spray area oscillating with an adjustable amplitude of preferably less than 500 mm. By the term “spray area”, it is referred to the target area of the at least one mat layer.

During the spraying, as disclosed hereinabove, the at least one mat layer is wetted on preferably both sides with the polyurethane resin composition, also described hereinabove. It is particularly preferred that the spraying of the polyurethane resin composition is done on both the sides of the at least one mat layer.

Handling of the at least one mat layer can be either manually or automatically. By the term “automatically”, it is referred to the handling of the at least one mat layer via a human interface, for instance, using industrial robots. In a preferred embodiment, an industrial robot that has preferably 6 axes and is especially tailored for production facilities using flexible robot-controller automation is employed. The robot is operated by means of a process software incorporated into a control cabinet. The control is suitable for communicating with external control systems. The robot can be equipped with a highly developed dual port safety system, the functions of which are continuously monitored. In case of a failure or malfunction, the electric supply of the motors can be switched off and brakes activated. Furthermore, the movement of each axes can be limited by software functions. In a preferred embodiment, the robot is driven via brushless three phase servomotors with brakes on all axes.

The pre-impregnated blank obtained in step (S1) is subsequently compression moulded in step (S2), for example, in a heated compression molding tool and is compressed in accordance with the required panel construction geometry and hardened. Subsequently, it is optionally possible, while the panel construction is left in the compression molding tool, for a contour cut, that is to say, coarse cutting to shape, to be performed around the tool or around the tool geometry.

Preferably, it is also possible, if necessary, for the panel construction to be cooled or thermally stabilized in the compression molding tool or outside the compression molding tool, more preferably cooled or thermally stabilized in a further tool, in particular in a workpiece cooling device.

In accordance with the embodiments, “thermally stabilized” is to be understood to mean that the panel construction assumes a temperature below the previous conversion temperature in order to attain a stable state. Here, the cooling in a workpiece cooling device makes it possible to realize the shortest production time, in particular with regard to continuous production of only one panel construction.

Preferably, tempering of the panel construction, that is to say a temperature process, in order for distortions to be compensated and/or the level of cross-linking of the materials to be increased, is performed in a further tool or in a further device. For example, it may be provided that, for cooling, the panel construction is merely placed on a frame or by way of one side on a surface. Use may however also be made of a closed cooling device which surrounds the panel construction around the full circumference and in which the temperature can be regulated. Further cooling of the panel construction can optionally be performed.

Preferably, the cooling can be followed by trimming of the outer contour, or cutting to shape of the side regions/edges, in accordance with the required panel construction contour and optionally also a chip-removing machining process, such as, for example, milling of the outer contour and milling and drilling for inserts and other similar recesses in the panel construction.

In another aspect, the presently claimed invention is directed to use of the panel construction as described herein, or as obtained by the process as described herein as an automotive part.

In yet another aspect, the presently claimed invention is directed to an automotive part comprising the panel construction as described herein or as obtained by the process as described herein.

Preferred automotive parts comprise of a lower sound shield, acoustical belly pan, aero shield, splash shield, underbody panel, chassis shield, door module, rear package or leaf spring.

The process according to the invention is illustrated in more detail by the accompanying figures.

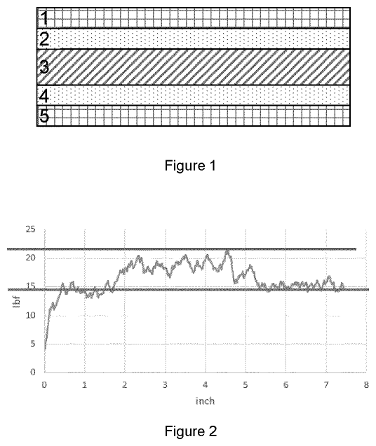

FIG. 1 reveals sandwich structure of the final assembly which is composed of Layer 1: Thermoplastic sheets such as PMMA; Layers 2 and 4: Impregnated mat layers with polyurethane through spraying polyurethane mixture; Layer 3: Honeycomb made of cardboard or thermoplastics or metals; Layer 5: Optional thermoplastic sheets such as PMMA.

FIG. 2 reveals peel force-displacement of inventive example (IE1). The graph shows typical peel force measured during cohesive delamination of the thermoplastic sheet from the honeycomb composite

The composition according to the presently claimed invention has at least one of the following advantages:

1. The isocyanate-reactive composition of the presently claimed invention has low viscosity (≤2000 cps at 23 C) and high lubricating ability.

2. The isocyanate-reactive composition of the presently claimed invention has a high castor oil content that results in the composition being less toxic and environmentally benign.

3. The polyurethane resin of the presently claimed invention has a high adhesion/bonding with thermoplastics and ensures greater wettability of mat layer.

4. The polyurethane resin of the presently claimed invention is adaptable to spray molding techniques.

The present invention is illustrated in more detail by the following embodiments and combinations of embodiments which result from the corresponding dependency references and links:
I. An isocyanate-reactive composition for manufacture of a polyurethane resin, said composition comprising:
   A. castor oil
   B. at least one polyether polyol having an average functionality of from 2.0 to 4.0
   C. at least one chain extender
   D. at least two catalysts selected from amine catalysts and/or alkyl tin catalysts.
II. The composition according to any of the embodiments I, wherein the weight ratio of polyether polyol to castor oil is in the range of from 0.5 to 6.0.
III. The composition according to embodiments I to II, wherein the castor oil content is in the range of from 25 to 60 wt. % with respect to the total weight of the composition.
IV. The composition according to any of the embodiments I to III, wherein the at least one polyether polyol has a hydroxyl number of from 15 mg KOH/g to 1800 mg KOH/g as determined by DIN 53240.
V. The composition according to any of the embodiments I to IV, wherein the at least one polyether polyol content is in the range of from 35 to 65 wt. % with respect to the total weight of the composition.
VI. The composition according to any of the embodiments I to V, wherein the at least one chain extender content is in the range of from 1 to 15 wt. % with respect to the total weight of the composition
VII. The composition according to any of the embodiments I to VI, wherein the at least two catalysts selected from diethyltoluenediamine, dioctyltin dithioglycolate, or 1-[bis[3-(dimethylamino)propyl]amino]-2-propanol
VIII. The composition according to any of the embodiments I to VII, wherein the composition comprises diethyltoluenediamine, dioctyltin dithioglycolate, and 1-[bis[3-(dimethylamino)propyl]amino]-2-propanol.
IX. A polyurethane resin obtainable by a process comprising reacting:
   A. an isocyanate; and
   B. the isocyanate-reactive composition according to any of the embodiments I to VIII.
X. The polyurethane resin according to embodiment IX, the isocyanate comprises methylene diphenyl diisocyanate, polymeric methylene diphenyl diisocyanate or a combination thereof.
XI. The polyurethane resin according to any of the embodiments IX to X, wherein the molar ratio of the sum total of the functionalities of the isocyanate-reactive composition used to the sum total of the functionalities of the isocyanate used is in the range from 1:0.8 to 1:1.3.
XII. The polyurethane resin according to any of the embodiments IX to XI, wherein said resin is adaptable to spray molding.
XIII. A panel construction comprising:
   (A) at least one mat layer,
   (B) a polyurethane film prepared from a polyurethane resin composition obtainable by a process comprising reacting:
      (a) an isocyanate, and
      (b) the isocyanate-reactive composition according to any of the embodiments I to VIII,
   (C) a honeycomb layer adjacent to the mat layer and in contact with the polyurethane film, wherein the polyurethane resin composition is sprayed onto the at least one mat layer to form the polyurethane film.
XIV. The panel construction according to embodiment XIII, wherein the mat layer comprises non-woven cellulosic bast fiber, non-woven polyester fiber, poly(methyl methacrylate), acrylonitrile butadiene styrene (ABS), polycarbonate, polypropylene, glass fiber, or a combination thereof.
XV. The panel construction according to any of the embodiments XIII to XIV, wherein the isocyanate comprises methylene diphenyl diisocyanate, polymeric methylene diphenyl diisocyanate or a combination thereof.
XVI. A process for preparing a panel construction, said process comprising the steps of:
   (S1) spraying a polyurethane resin composition onto at least one surface of a mat layer, wherein said polyurethane resin composition is obtainable by a process comprising reacting:
      (a) an isocyanate, and
      (b) the isocyanate-reactive composition according to any of the embodiments I to VIII; and
      wherein said polyurethane resin composition forms a polyurethane film on the at least one surface of a mat layer;
      and resulting in a pre-impregnated blank,
      and
   (S2) compression molding the pre-impregnated blank along with a honeycomb layer.
XVII. The process according to embodiment XVI, wherein the polyurethane resin composition is atomized.
XVIII. The process according to any of the embodiments XVI to XVII, wherein the process is a spray transfer molding process.
XIX. Use of the panel construction according to any of the embodiments XIII to XV or as obtained by the process according to any of the embodiments XVI to XVIII as an automotive part.
XX. The use according to embodiment XIX, wherein the automotive part comprises of a lower sound shield, acoustical belly pan, aero shield, splash shield, underbody panel, chassis shield, door module, rear package shelf or leaf spring.
XXI. An automotive part comprising the panel construction according to any of the embodiments XIII to XV or as obtained by the process according to any of the embodiments XVI to XVIII.

### Examples

The presently claimed invention is illustrated by the non-restrictive examples which are as follows:

Raw materials
POLYETHER POLYOL (P)

| | |
|---|---|
| P 1 | Pluracol 1158, having a functionality 3.0 and |
| | hydroxyl number from to 905 mg KOH/g to 935 |
| | mg KOH/g, obtained from BASF |
| P 2 | Pluracol PEP 450, having a functionality 4.0 and |
| | hydroxyl number from to 540 mg KOH/g to |
| | 570 mg KOH/g, obtained from BASF |
| P 3 | Pluracol SG 360, having a functionality 4.0 and |
| | hydroxyl number from to 350 mg KOH/g to 375 |
| | mg KOH/g, obtained from BASF |

CHAIN EXTENDER

| | |
|---|---|
| E1 | Ethylene glycol |

ISOCYANATE (ISO)

| | |
|---|---|
| ISO 1 | Polymeric MDI with NCO content of |
| | 31.5 wt.-%, obtained from BASF |

CASTOR OIL (C)

| | |
|---|---|
| C 1 | Vertellus DB Castor oil (PC-10)- which contains |
| | 90% triglyceride of Recinioleic Acid |

BLOWING AGENT

| | |
|---|---|
| BA 1 | Cyclopentane |
| BA 2 | Water |

CATALYST (CA)

| | |
|---|---|
| CA 1 | Amine catalyst ETHACURE 100, obtained from Albermarle |
| CA 2 | Delayed amine catalyst KX115, which is 1-[bis[3- |
| | (dimethylamino)propyl]amino]-2-propanol |
| | blocked with adipic acid and mixed with |
| | ethylene glycol, obtained from BASF |
| CA 3 | Alkyl tin catalyst Fomrez UL29, |
| | obtained from Galata chemicals |

ADDITIVES (A)

| | |
|---|---|
| A 1 | Silicone surfactant Tegostab B 8408, obtained |
| | from Evonik (flame retardant) |
| A 2 | High molecular weight polyester Loxiol G71S, obtained |
| | from Emery oleochemicals (release agent) |

Standard method

| | |
|---|---|
| DIN 53240 | OH value |

The peel test was performed similar to posi test but modified based on average of (peel force [lbf])/(length [in]. For peel test, samples were cut into 2 in width and 6 in length. The thermoplastic is then peeled using a universal tensile tester machine and measured the peel force. That peel force obtained is the indication of the adhesion between the thermoplastic and the composite

### General Synthesis of Mixture for Producing PU Foam

The aforementioned raw materials were added in the amounts mentioned in Table 1 in both the A-side and B-side components (all in wt. %). Both the A-side and B-side components were then added to a mixing device, such as the static mixer of a spray equipment or other mixing approach like a mixing cup, to obtain a desired level of mixing. For instance, the mixture was subjected to mixing at rpm of 3000 and the temperature of A-side and B-side components was maintained of from 25° C. to 30° C. IE 1 represents polyurethane resins obtained with inventive isocyanate-reactive composition, whereas CE 1 represents resins developed with comparison. The isocyanate-reactive composition of CE 1 does not comprise castor oil.

The PU foams thus obtained, were subsequently processed for testing and the properties determined.

TABLE 1

| | | |
|---|---|---|
| Ingredient | IE1 | CE1 |

A-side component (wt. %)

| | | |
|---|---|---|
| ISO 1 | 160 | 160 |

B-side component (wt. %)

| | | |
|---|---|---|
| P 1 | 43 | 20 |
| E 1 | 5 | 12 |
| P 2 | — | 26.1 |
| P 3 | — | 25.4 |
| C 1 | 36.8 | — |
| CA 1 | 5.1 | 4 |
| CA 2 | 2.5 | 2.8 |
| CA 3 | 0.02 | — |
| BA 2 | 0.4 | 0.4 |
| A 2 | — | 0.4 |
| A 3 | 4 | — |
| BA 1 | 1.4 | 1.4 |

Results

| | | |
|---|---|---|
| Peel force (N/cm) | 14.5 | 4.2 |

The inventive isocyanate-reactive composition results in a low-viscosity composition (≤2000 cps at 23 C) that is suitable for easy processing. The resultant polyurethane resin obtained by reacting said isocyanate-reactive composition is noted to results in surprising improvement in adhesion to thermoplastic adhesion. This is clearly identified by the high peel force values displayed in Table 1. The surprisingly high peel force displacement is clearly identifiable in the FIG. 2. It is noted from the graph that the peel force range is high enough to prevent future delamination. The significantly high peel force required to displace the polyurethane film from a thermoplastic mat layer is clearly indicative of the high adhesion towards thermoplastics. Several comparative systems were compared (for instance CE 1) and the peel force was found to be substantially lower. Also, the resin displayed strong bonding to PMMA/PC.

1. An isocyanate-reactive composition for manufacture of a polyurethane resin, said composition comprising:
castor oil;
at least one polyether polyol having an average functionality of from 2.0 to 4.0;
at least one chain extender; and
at least two catalysts selected from the group consisting of an amine catalyst an alkyl tin catalyst, and mixtures thereof.

2. The composition according to claim 1, wherein a weight ratio of the at least one polyether polyol to the castor oil is in a range of from 0.5 to 6.0.

3. The composition according to claim 1, wherein the castor oil has a content in a range of from 25 to 60 wt. % with respect to a total weight of the composition.

4. The composition according to claim 1, wherein the at least one polyether polyol has a hydroxyl number of from 15 mg KOH/g to 1800 mg KOH/g as determined by DIN 53240.

5. The composition according to claim 1, wherein the at least one polyether polyol has a content in a range of from 35 to 65 wt. % with respect to a total weight of the composition.

6. The composition according to claim 1, wherein the at least one chain extender has a content in a range of from 1 to 15 wt. % with respect to a total weight of the composition.

7. The composition according to claim 1, wherein the composition comprises diethyltoluenediamine, dioctyltin dithioglycolate, and 1-[bis[3-(dimethylamino)propyl]amino]-2-propanol.

8. The composition according to claim 1, wherein the at least one chain extender is different from the at least one polyether polyol.

9. A polyurethane resin obtained by a process comprising reacting:
an isocyanate; and
the isocyanate-reactive composition according to claim 1.

10. The polyurethane resin according to claim 8, wherein the isocyanate is selected from the group consisting of methylene diphenyl diisocyanate, polymeric methylene diphenyl diisocyanate, and combinations thereof.

11. The polyurethane resin according to claim 9, wherein a molar ratio of a sum total of functionalities of the isocyanate-reactive composition used to a sum total of functionalities of the isocyanate used is in a range from 1:08 to 1:1.3.

12. The polyurethane resin according to claim 9, wherein said resin is adaptable to spray molding.

13. A panel construction, comprising:
at least one mat layer, and
a polyurethane film prepared from a polyurethane resin composition obtained by a process comprising reacting:
an isocyanate, and
the isocyanate-reactive composition according to claim 1, and
a honeycomb layer adjacent to the at least one mat layer and in contact with the polyurethane film,
wherein the polyurethane resin composition is sprayed onto the at least one mat layer to form the polyurethane film.

14. The panel construction according to claim 13, wherein the at least one mat layer comprises at least one fiber selected from the group consisting of non-woven cellulosic bast fiber, non-woven polyester fiber, poly(methyl methacrylate), acrylonitrile butadiene styrene (ABS), polycarbonate, polypropylene, glass fiber, and a combination thereof.

15. The panel construction according to claim 13, wherein the isocyanate comprises methylene diphenyl diisocyanate, polymeric methylene diphenyl diisocyanate, or a combination thereof.

16. A process for preparing a panel construction, said process comprising:
(S1) spraying a polyurethane resin composition onto at least one surface of a mat layer, wherein said polyurethane resin composition is obtained by a process comprising reacting:
an isocyanate, and
the isocyanate-reactive composition according to claim 1; and
wherein said polyurethane resin composition forms a polyurethane film on the at least one surface of a mat layer;
and resulting in a pre-impregnated blank,
and
(S2) compression molding the pre-impregnated blank along with a honeycomb layer.

17. The process according to claim 16, wherein the polyurethane resin composition is atomized in (S1).

18. The process according to claim 16, wherein the process is a spray transfer molding process.

19. An automotive part, comprising:
the panel construction according to claim 13.

20. The automotive part according to claim 19, further comprising:
at least one of
a lower sound shield, an acoustical belly pan, an aero shield, a splash shield, an underbody panel, a chassis shield, a door module, a rear package shelf or a leaf spring.

21. (canceled)
